(19) United States
(12) Patent Application Publication
(10) Pub. No.: US 2004/0215737 A1
(43) Pub. Date: Oct. 28, 2004

(54) Instant messaging system with dynamic displaying of affinity among users

(76) Inventor: Roberto Della Pasqua, Savignano Sul Rubicone (RN) (IT)

Correspondence Address: GRAYBEAL JACKSON HALEY LLP, Suite. 350, 155-108th Avenue N.E., Bellevue, WA, 98004-5973, US

(21) Appl. No.: 10/741,817

(22) Filed: Dec. 18, 2003

(30) Foreign Application Priority Data
Dec. 18, 2002 (IT) MI2002A002870

(51) Int. Cl. G06F 15/16

(52) U.S. Cl. 709/207

(57) ABSTRACT

A method of managing a messaging service is proposed for use in a data processing system with distributed architecture including at least one server computer and a plurality of client computers, the service being provided by the at least one server computer for a plurality of users each one associated with a corresponding client computer, wherein the method includes the steps for each user of: providing personal information of the user to the at least one server computer, determining, under the control of the at least one server computer and for each other user, an affinity value indicating a level of affinity of the user with the other user according to a comparison between the personal information of the user and the personal information of the other user, transmitting each affinity value from the at least one server computer to the client computer of the user, and providing an indication of each affinity value to the user by means of the corresponding client computer.

### PRIORITY CLAIM

This application claims priority from Italian patent application No. MI2002A002670, filed Dec. 18, 2002, which is incorporated herein by reference.

### TECHNICAL FIELD

The present invention relates to a method and a corresponding system for managing a messaging service.

### BACKGROUND

Messaging services (for example, the discussions in real-time or chats) have become increasingly common, especially in the Internet. Those services allow a user to send to and receive from other users information of different type. The messaging services are managed by one or more server computers of a data processing system with distributed architecture; each user is connected to the server computer (by means of a communication network) using his/her client computer.

However, the widespread diffusion of these services has greatly complicated their use. Indeed, the wide availability of several kinds of services makes their choice by a user very difficult.

A commonplace solution for facilitating the use of the messaging services is that of collecting personal information for the different users (such as the age, the sex, the profession, the hobbies, and the like). In this way, each user can verify the characteristics of the other users at any moment (for example, before deciding his/her access to a chat or for selecting a specific user to which a determined message is to be sent).

A drawback of this solution consists in that it involves a considerable increase of the traffic in the communication network. Indeed, whenever a user desires to know the characteristics of another user, the whole respective personal information has to be downloaded from the server on the client of the user. Particularly, in the case of a chat with a high number of active users, the same operation must be repeated for every user (with a heavy increase of the workload of the server managing the chat).

This drawback impairs the performance of the messaging service provided by the server (and also of other possible services implemented thereon at the same time). Furthermore, this can lead to congestion of the communication network (with negative consequences on the whole system).

The above-described method is also very annoying for the user. For example, a new user desiring to obtain general information on a chat is forced to download the information relating to every user in succession. This operation involves a great waste of time, so that it is very often impracticable. All that contributes to worsen the messaging service quality notably.

### SUMMARY

It is an object of the present invention to overcome the above-mentioned drawbacks. In order to achieve this object, a method as set out in the first claim is proposed.

Briefly, the present invention provides a method of managing a messaging service for use in a data processing system with distributed architecture including at least one server computer and a plurality of client computers, the service being provided by the at least one server computer for a plurality of users each one associated with a corresponding client computer, wherein the method includes the steps for each user of: providing personal information of the user to the at least one server computer, determining, under the control of the at least one server computer and for each other user, an affinity value indicating a level of affinity of the user with the other user according to a comparison between the personal information of the user and the personal information of the other user, transmitting each affinity value from the at least one server computer to the client computer of the user, and providing an indication of each affinity value to the user by means of the corresponding client computer.

Furthermore, the present invention proposes different programs for performing the method, together with corresponding products storing those programs; a data processing system for managing the messaging service, a server computer and a client computer of the system are also encompassed.

### BRIEF DESCRIPTION OF THE DRAWINGS

Further features and the advantages of the solution according to the present invention will be made clear by the following description of a preferred embodiment thereof, given purely by way of a non-restrictive indication, with reference to the attached figures, in which:

FIG. 1a schematically shows a data processing system in which the method of the invention is applicable;

FIG. 1b is a pictorial representation of a generic computer of the system;

FIG. 2 shows the main software components used for implementing the method;

FIGS. 3a-3c illustrate an activity diagram describing the logic of a method for managing a chat in the system; and

FIG. 4 is an exemplary window associated with a channel of the chat.

### DETAILED DESCRIPTION

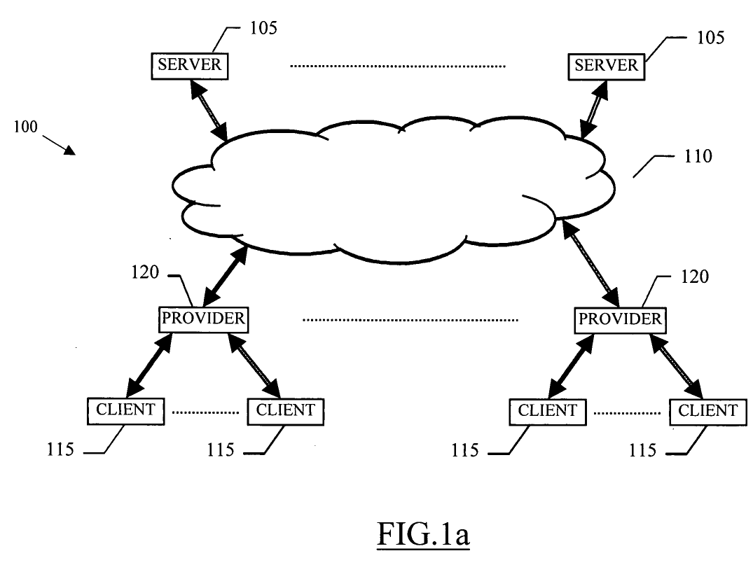

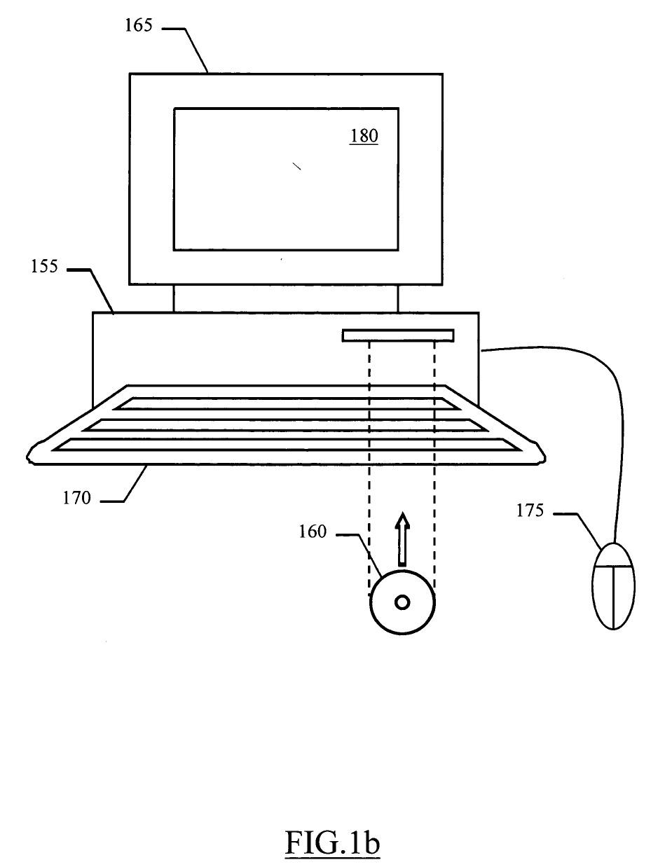

With reference in particular to FIG. 1a, a data processing system 100 with distributed architecture, typically Internet-based, is shown. The Internet is formed by millions of server computers 105, which are connected to each other through a network infrastructure 110. Client computers 115 access the Internet by means of computers that operate as access providers 120. This allows the clients 115 to use shared resources supported by the servers 105; particularly, the users of the clients 115 can connect to a chat managed by one or more servers 105.

A chat consists of a service that allows two or more users to exchange messages in real-time. Each user can then send information of various types to the server, which information is immediately duplicated on the clients of the other users. In general, the chat supports multiple sessions (known as chat rooms), each one managed through a dedicated communication channel.

The structure of a generic computer (client or server) is illustrated in FIG. 1b. The computer, for example, a Personal Computer (PC), comprises a case 155; the case 155 houses the various electronic circuits controlling the operation of the computer (such as a microprocessor and a working memory), in addition to a hard-disk and to a driver for reading optical disks (CD-ROMs) 160. A monitor 165 and a keyboard 170 are connected to the case 155 in a conventional manner. The computer further includes a mouse 175, which is used for handling the position of a pointer (not shown in the drawing) on a screen 180 of the monitor 165.

In any case, the concepts of the present invention are also applicable when the system has a different architecture (for example, based on a local network, or LAN), or when an equivalent service is used (such as an instant messaging service); similar considerations apply if the computers have another structure or include different units, if the clients are replaced with equivalent devices (such as a palm-top computer or a mobile telephone), and the like.

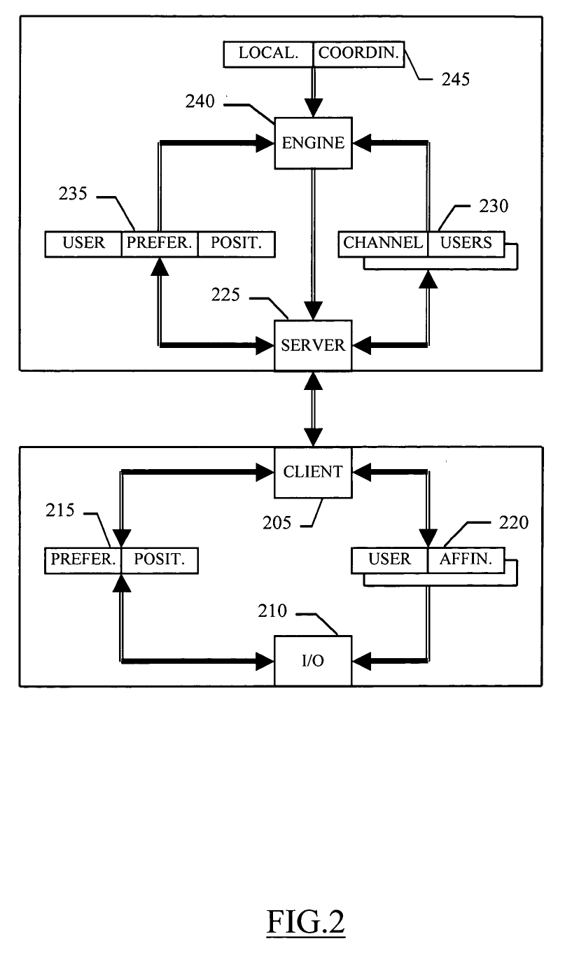

Passing now to FIG. 2, a partial content of the working memory of the server that manages the chat and of a client exploited by a generic user thereof is shown. Typically, the information (programs and data) is stored on the respective hard disks and loaded (at least partly) in the working memories when the programs are running. The programs are initially installed onto the hard disks from CD-ROM.

Particularly, a module 205 that is installed on the client allows its user to access the chat. The client module 205 interfaces with an input/output (I/O) module 210, which consists of a series of drivers for the different peripheral units of the client. Each channel of the chat is managed through a corresponding window that is displayed on the monitor of the client; this window shows the messages sent by the various users that are active in the channel, and allows the user of the client to enter new messages.

A data structure 215 stores personal information of the user. The personal data structure 215 contains a preference table of the user and his/her geographical position. The preference table consists of a series of rows (for example, 20), each one for a corresponding category of personal information (typically grouped into homogeneous sets); for example, the preference table includes rows relating to the user's interests, his/her physical aspect, his/her tastes, his/her character, his/her skills, and so on. For each active category, a value set by the user (for example, consisting of an integer number from 0 to 10) is stored. Instead, the geographical position is defined by the name of a locality or by a couple of geographical coordinates.

The I/O module 210 allows the user to display and modify the personal data structure 215. The personal data structure 215 is kept on the client, in order to be sent to the server by the module 205 during a login to the chat or following an updating thereof; alternatively, the personal data structure 215 is created on the server (during a registration of the user) and is downloaded to the client when necessary.

For each channel the client module 205 further receives a user list 220. The list 220 consists of a row for each other user that is active in the channel (identified by means of a corresponding nickname). The row stores, in addition to the identifier of the other user, a value (formed by one or more components) indicating a level of affinity of the user of the client with that other user; for example, for each other user a preferential affinity value (from 0 to 10) and a geographical affinity value (from 0 to 10 for three distance ranges) are stored. The user list 220 is provided to the I/O module 210, in order to be displayed within the window associated with the corresponding channel.

The client module 205 communicates with a corresponding module 225 on the server. The server module 225 receives the messages sent by the clients of the various users, and distributes them to the clients of all the other users that are active in the same channel; furthermore, it manages the creation of a new channel, the deletion of existing channels, as well as the insertion and the removal of users in the various active channels. For this purpose, the server module 225 controls a channel file 230; this file 230 stores a list of the users that are active in each channel.

The server module 225 further manages a user repository 235. The user repository 235 contains a record for each user registered on the server (or even not registered, but currently active in one or more channels). The record stores the preference table of the user and his/her geographical position.

The channel file 230 and the user repository 235 are input to a comparison engine 240. The engine 240 calculates values of affinity among the active users in the various channels; those affinity values are then provided to the server module 225 in order to be transmitted to the relevant clients. For this purpose, the engine 240 accesses a predefined locality table 245. The table 245 associates the corresponding geographical coordinates with each locality (in a specific list).

In any case, the concepts of the present invention are also applicable when a different chat system is used, or when other personal information of the users is supported; furthermore, the values for each category can be different, the affinity level can be partitioned in another way, or a different number of affinity value components (down to a single one) can be provided.

Alternatively, the preference table includes artificial information set by the user; this allows a complete customization of the definition of the affinities with the other users, according to various desired comparison criteria (not necessarily equal to the preferences of the user).

Similar considerations apply if the programs are provided on any other computer readable medium (such as one or more floppy-disks), if the programs and the data are structured in a different way, if other modules or functions are provided, and the like.

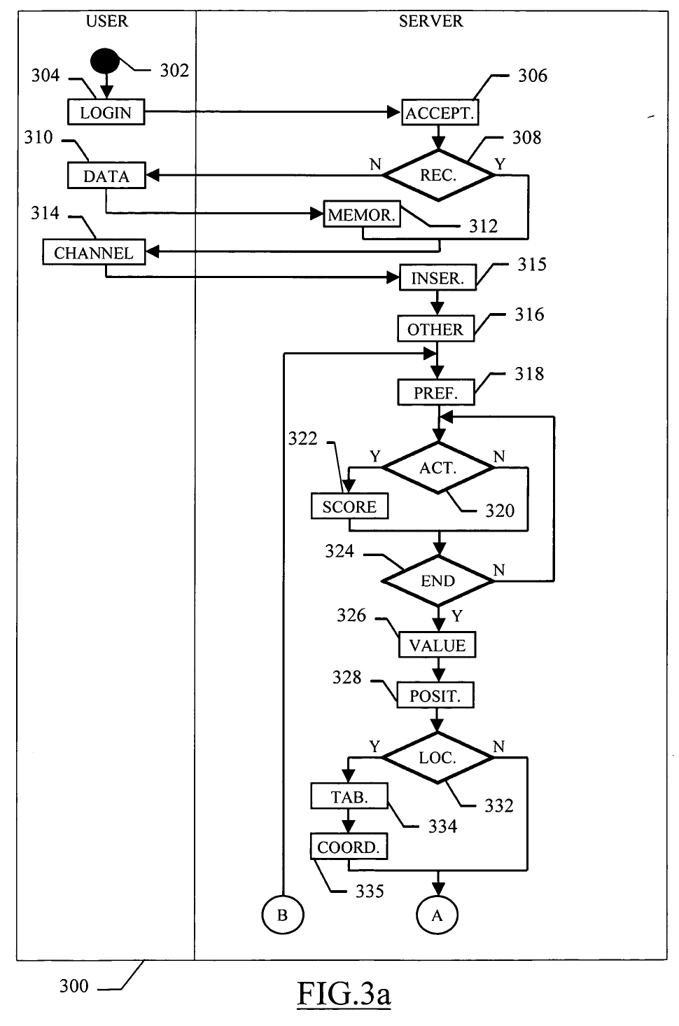

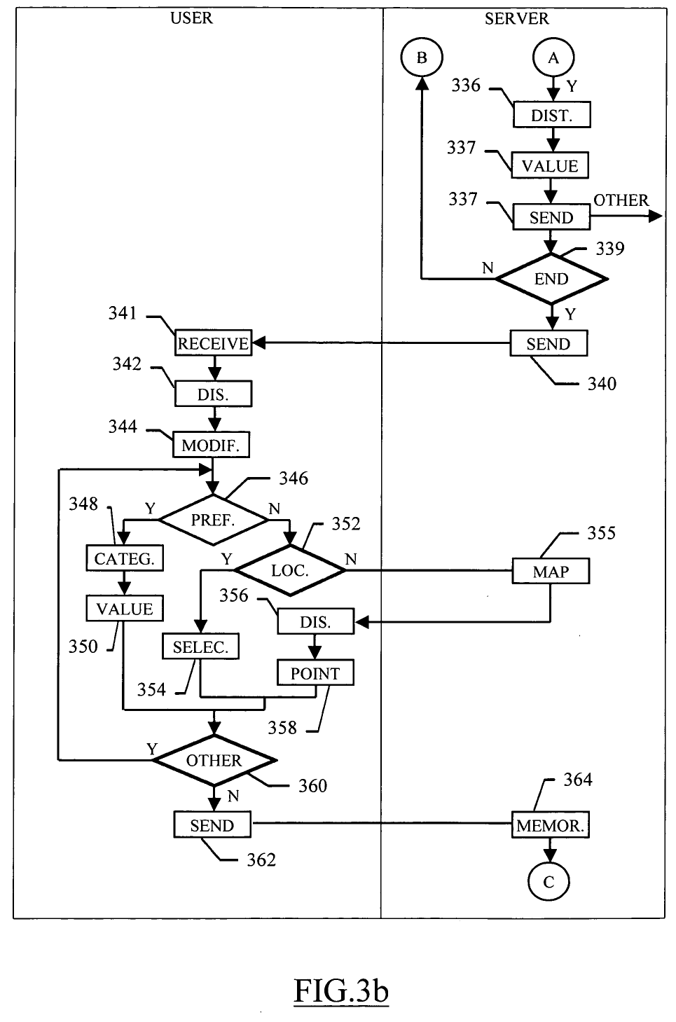

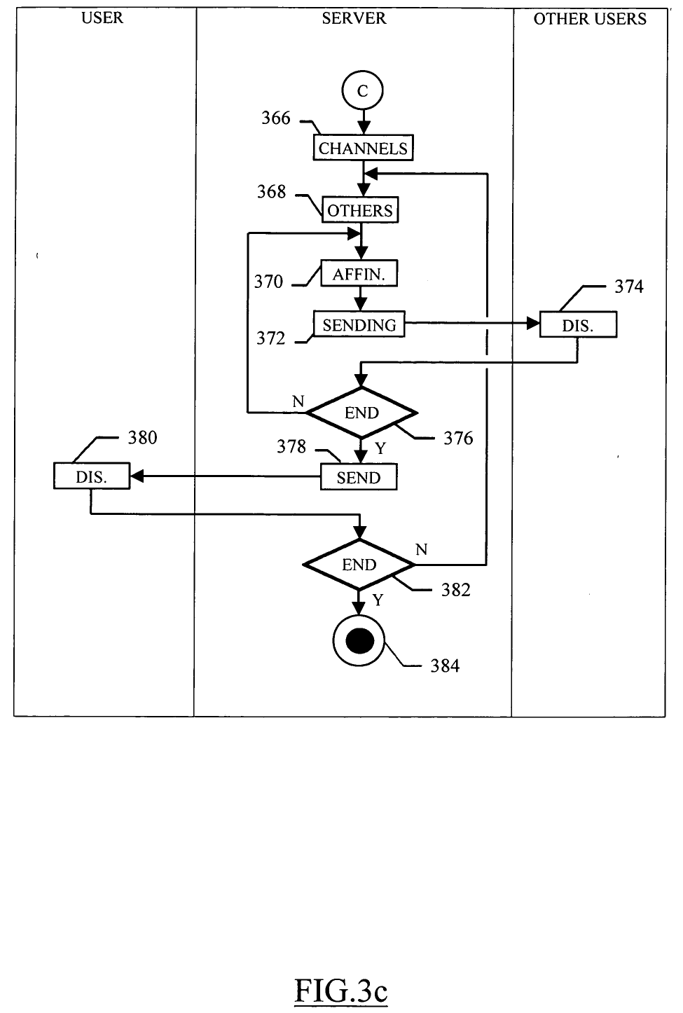

The managing logic of the chat is illustrated in the activity diagram of FIGS. 3a-3c. A corresponding process 300 begins at the black start circle 302 in the swim-lane of a generic user (active on a respective client). Continuing to block 304, the user requires a login to the chat. In response to this request, the user is accepted by the server at block 306. A verification is then performed at block 308 for determining whether the user is registered on the server. If not, the process 300 passes to block 310 in the swim-lane of the user, wherein the respective personal data structure (preference table and geographical position) is transmitted to the server. Returning to the swim-lane of the server, the personal data structure of the user is inserted into the user repository at block 312. The process then proceeds to block 314. On the contrary, if the user is already registered the process directly descends from block 308 into block 314.

Considering now block 314, the user accesses a channel of the chat. In response thereto, the server at block 315 inserts the user into the channel file. The process then continues to block 316, wherein the server obtains the list of the other users that are active in the channel. The affinity table of the user with the other users of the channel is then created executing the following loop for each other user (starting from the first one).

The loop begins at block 318, wherein the server accesses the respective preference tables (stored in the user repository). For each category of the preference table (starting from the first one), the process verifies at block 320 whether this category has been enabled by the user and by the other user. If both the conditions are met, a total score (initially equal to zero) is incremented at block 322 by the absolute value of the difference between the values of the category for the user and for the other user; the process then continues to block 324 (which is reached directly if the category has not been enabled by at least one out of the user and the other user).

A verification is then performed at decision block 324 to determine whether the last category of the preference tables has been processed. If not, the method returns to block 320 for repeating the above-described operations with the next category. Once the whole preference table has been completed, the process passes to block 326. The preferential affinity value of the user with the other user is now determined according to the result of the above-described loop. Particularly, if the user and the other user have not enabled any category in common, the preferential affinity value is set to zero. On the contrary, the preferential affinity value is calculated as the complement to 10 of the total score divided by the number of categories in common. For example, let us consider the case in which the user and the other user have set the following preference tables:

| | |
|---|---|
| USER | OTHER USER |

| Active | Value | Active | Value |
|---|---|---|---|
| X | 2 | | |
| | | X | 6 |
| X | 5 | X | 4 |
| | | X | 0 |
| X | 7 | X | 5 |
| | | X | 9 |
| X | 0 | X | 2 |
| | | X | 10 |
| X | 10 | X | 8 |
| | | X | 7 |

In this case, the total score will be:

|5−4|+|7−5|+|0−2|+|10−8|=7

from which a preferential affinity value is obtained equal to:

10−7/4=8.25

(indicating a high affinity level between the user and the other user, due to the fact that the categories in common have very similar values).

Passing now to block 328, the server extracts the geographical position (locality name or geographical coordinates) of the user and of the other user from the respective records in the user repository. The process then branches at block 332. For each geographical position expressed by means of the locality name, the process accesses the locality table at block 334. Continuing to block 335, the geographical coordinates corresponding to the locality name are extracted from that table. The process then proceeds to block 336. On the contrary, if both the geographical positions are already expressed as coordinates (decisional block 332) the process descends into block 336 directly.

With reference now to block 336, the server calculates the distance between the geographical positions of the user and of the other user (the distance is set to an invalid value if the geographical position has not been set by at least one out of the user and the other user); the calculation is executed by means of a simple difference (to scale) between the corresponding geographical coordinates. Passing to block 337, the geographical affinity value of the user with the other user is now determined according to their distance. Particularly, if the distance is invalid or it is equal to or greater than 20,000 Km, the geographical affinity value is set to zero. On the contrary, the distance is assigned to a first range (lower than 200 Km), to a second range (from 200 Km to less than 2,000 Km) or to a third range (from 2,000 Km to less than 20,000 Km); the geographical affinity value is then calculated as the complement to 10 of the ratio between the distance and the higher limit of the respective range. For example, let us consider the case in which the distance between the user and the other user is equal to 140 Km. The distance is then included in the first range, so that the geographical affinity value will be:

10−140/200*10=3

(indicating that the distance between the user and the other user is rather high in the range up to 200 Km).

The user identifier and the (preferential and geographical) affinity value so calculated are transmitted to the client of the other user at block 338 (in order to update the respective user list). A verification is then performed at decision block 339 to determine whether the last other user of the channel has been processed. If not, the method returns to block 318 for calculating the affinity value of the user with the next other user of the channel. Once the iteration on the whole channel has been completed, the process passes to block 340.

The user list (including the respective affinity value for each other user) is now transmitted to the client of the user. The user list is received by the client at block 341 (in the respective swim-lane). As described in detail in the following, corresponding information is displayed at block 342 on the monitor of the client (in the window associated with the channel).

With reference now to block 344, the user selects (in the window of the channel) a command for changing the content of his/her own personal data structure. The user can choose at block 346 whether he/she desires to update the preference table or the geographical position. In the first case the blocks 348-350 are executed, whereas in the second case the blocks 352-358 are executed; in both cases, the process then passes to block 360.

Considering now block 348 (preference table update), the user selects a category to be enabled or disabled. The user at block 350 can then insert or modify the value of the category (if enabled); for example, the value is set by moving a button along a corresponding control bar.

Instead, when the user desires to modify his/her geographical position, the process branches at block 352 according to the selected definition mode. If the user has chosen to use the locality name, the process passes to block 354; in this case, the user can select the locality name in a predefined list. On the contrary, if the user has chosen to define the geographical position through its geographical coordinates, the graphic representation of one or more geographical maps is downloaded from the server at block 355 (in the respective swim-lane). The process then continues to block 356 in swim-lane of the user, wherein the geographical map is displayed on the monitor of the client (preferably, in a dedicated window). The user then selects a desired point on the map at block 358 (for example, clicking with the mouse).

The process merges at decision block 360. If the user desires to further update the content of his/her personal data structure, the process returns to block 346 waiting for a new command. Once the user ends the updating operation, the new personal data structure is transmitted to the server at block 362. In response thereto, the server at block 364 updates the respective record in the user repository accordingly.

The process then continues to block 366, wherein the server determines the channels in which the user is active. The updating to the user personal structure is then reflected in real-time on all the users of each channel (starting from the first one) by means of the following loop.

The loop starts at block 368, wherein the server obtains the list of the other users that are active in the channel. For each other user a new (preferential and geographical) affinity value with the user is calculated at block 370 (repeating the operations described above with reference to blocks 318-337). Continuing to block 372, the new affinity value is then transmitted to the client of the other user. In response thereto, the corresponding information that is displayed on the monitor of that client (in the window associated with the channel) is updated accordingly at block 374 (in the respective swim-lane). A verification is then performed at decision block 378 in the swim-lane of the server to determine whether the last other user of the channel has been processed. If not, the method returns to block 370 for calculating the new affinity value of the user with the next other user of the channel. Once the iteration on the whole channel has been completed, the process passes to block 378.

The new affinity values of the user with each one of the other users of the channel are now transmitted to the client of the user. In response thereto, the corresponding information that is displayed on the monitor of that client is updated accordingly at block 380 (in the respective swim-lane).

The process then verifies at block 382 in the swim-lane of the server whether the updating to the user personal data structure has been reflected on all the channels in which the user is active. If not, the process returns to block 368 for repeating the above-described operations on the next channel. Conversely, the process ends at the concentric white/black stop circles 384.

Similar considerations apply if an equivalent process is implemented, or if further functions are provided; for example, it is possible to provide an additional test that enables the execution of the loop for the calculation of the preferential affinity value only if both the preference tables have been enabled. In any case, the concepts of the present invention are also applicable when the personal information is provided to the server in another way, when a different login procedure is used, or when the (preferential and/or geographical) affinity value is determined in an alternative way; for example, in more sophisticated embodiments of the present invention the preferential affinity value is determined using fuzzy logic maps or similarity algorithms, whereas the distance is calculated using three-dimensional arcs. Alternatively, the values of the various categories are set in a different way (for example, typing a number), the new value of each category is immediately transmitted to the server (without waiting for the end of the updating command), and the like. As a further improvement, it is also possible to use self-adaptive algorithms, which automatically update the personal data structures of the users according to their behavior in the chat (for example, setting an additional preference based on the characteristics of the users with which the communication is more frequent).

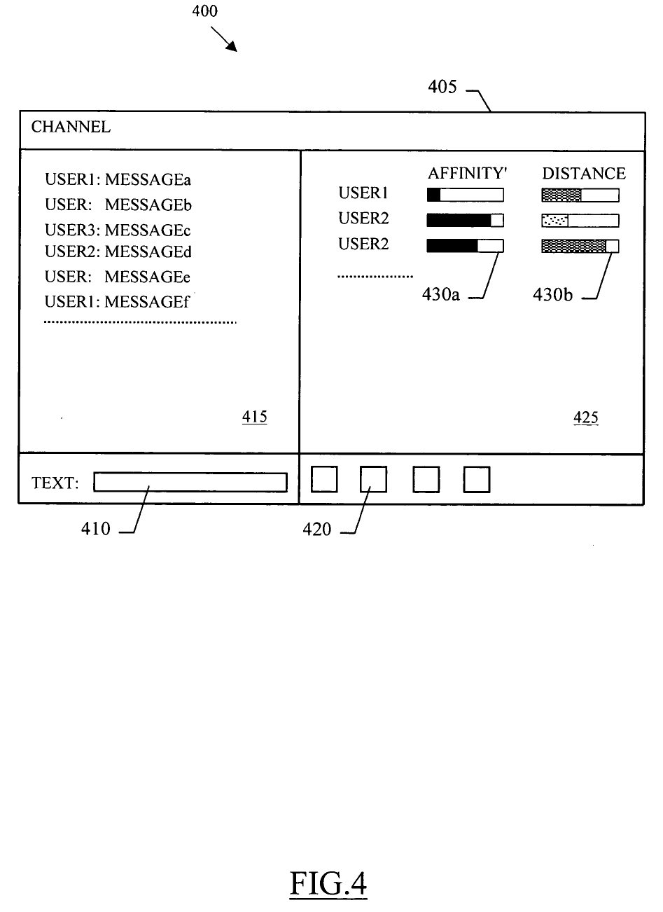

Passing now to FIG. 4, an exemplary window 400 that is used by a channel of the chat is illustrated. The window 400 is provided with a bar 405 wherein the name of the channel is shown. A frame 410 is used for typing text messages to be sent to the server. All the messages inserted in the channel (by the various users) are displayed in a scroll window 415. Several commands 420 are available to the user for managing the channel (for example, for filtering the messages or for modifying his/her personal data structure).

The information indicating the affinity value of the user with each other user of the channel is displayed in a frame 425. Particularly, for each other user two filling bars are provided, which are shown beside the respective nickname. A filling bar 430a provides a graphic representation of the preferential affinity value (from empty for 0 to completely filled for 10). Instead, a further filling bar 430b is used for the geographical affinity value. The filling bar 430b can take different colors according to the distance range (for example, green for the first one, blue for the second one and red for the third one); the filling state of the bar 430b then represents the value in the respective range.

In any case, the concepts of the present invention are also applicable when the channel is managed through a different graphic interface, or when the affinity value is represented in another way (for example, using different colors, forms or shades for the various affinity levels).

More generally, the present invention proposes a method of managing a messaging service. The method is used in a data processing system with distributed architecture including one or more server computers and a plurality of client computers; the service is provided by the server computer for a plurality of users each one associated with a corresponding client computer. The method starts with the step of providing personal information of the user to the server computer. For each other user, an affinity value (indicating a level of affinity of the user with the other user) is calculated under the control of the server computer, according to a comparison between the personal information of the user and the personal information of the other user. The method continues with the step of transmitting each affinity value from the server computer to the client computer of the user. An indication of each affinity value is then provided to the user by means of the corresponding client computer.

The proposed solution greatly reduces the network traffic in the data processing system in which the messaging service is implemented. This method allows providing information relating to all the users of the service exploiting the data processing system resources at their best (and without substantially increasing the workload of the server).

The devised method greatly improves the performance of the messaging service (and also of any other services implemented on the same server). Furthermore, this avoids blocking the network resources (with positive effects on the whole system).

The solution of the invention makes the use of the messaging service easier. Particularly, it allows obtaining general information on the other users in a simple and fast way. All that contributes to increase the quality of the messaging service notably.

It is important to point out that the proposed method is absolutely new, since for the first time it offers the possibility to execute affinity comparisons among the users of the messaging service (preferably in a dynamic way).

The preferred embodiment of the invention described above offers further advantages.

Particularly, the client of the user displays a graphic representation of the affinity values with the other users.

This feature makes the method of the invention very effective.

However, different modes of presentation of the affinity information (for example, by means of numerical values or sounds) are not excluded.

Preferably, the personal information consists of values assigned to various categories of preferences.

This feature allows exploiting the advantages of the proposed method at its best, ensuring good flexibility at the same time.

As a further enhancement, the value of each category is selected in a series of predefined choices.

This greatly simplifies the management of the personal information that is collected.

Without detracting from the general applicability of the invention, the affinity value is calculated by means of a score based on the differences between the values that have been set for the common categories.

This algorithm is very fast, but at the same time provides enough accurate results in most practical applications.

In any case, the solution according to the present invention leads itself to be implemented also managing the personal information in other way, choosing the values of the various categories differently (for example, only setting their enabling), or calculating the affinity value with another algorithm.

In addition or in alternative, the personal information includes the user geographical position.

This feature provides a further degree of refinement of the proposed method.

In a particular embodiment of the invention, the geographical position is provided selecting the locality name.

This procedure is preferred when the user lives in big towns (since it provides a high precision).

In another embodiment, the geographical position is selected on the graphic representation of a map.

Instead, this procedure is exploited when the user lives in small villages (since it offers the greatest flexibility of use).

Preferably, the affinity value is calculated according to the distance between the users.

The proposed value provides very useful information in several practical situations (for example, when the need of a successive personal meeting between the users is foreseen).

A suggested choice for the calculation of the distance (when the geographical position is defined by the locality name) is that of obtaining the corresponding geographical coordinates from a predefined table.

This makes the algorithm very simple, but at the same time effective.

Alternatively, different types of personal information are supported (down to a single one out of the preference categories and the geographical positions), or the geographical position can be set only selecting either the locality name or the point on the map (or with another procedure); furthermore, the affinity value is calculated also considering other factors in addition to the distance (for example, the characteristics of the region, nation, and the like), or the geographical coordinates are obtained from the locality in another way.

In a preferred embodiment of the present invention the affinity information is updated in real-time in response to any updating of the personal information of the user.

This feature allows keeping the affinity information distributed in the system always consistent.

Advantageously, the new affinity information is calculated by the server and then reflected on the various clients.

This makes it possible to maintain a client-server model, without excessively impairing the performance.

In any case, the proposed solution is also suitable to used without updating the affinity values in real-time, or in a peer-to-peer network, or moving the calculation of the new affinity values to the various clients, thereby saving bandwidth memory and processing resources.

The method of the invention is particularly advantageous in a chat.

However, the devised solution is well suited to a number of other applications (even with the users that are off-line). For example, an alternative embodiment of the invention provides the definition of a virtual user associated with a service operator (with the respective personal data structure). For example, this allows the operator to select the preferred commercial partners in a virtual meeting, or to identify the most suitable candidates in an on-line aptitude test; furthermore, this functionality can be used for implementing a preferential advertising distribution engine or for selecting users that are surfing in a site (in order to contact them with customized commercial proposals). In another application, the moderator of a virtual meeting can create preference tables to be dynamically submitted to the users (for example, during a poll on business strategies); this allows determining the consent to the different proposals on the part of the working group, and possibly partitioning the original group into secondary groups according to similar affinities.

Advantageously, the solution according to the present invention is implemented by a computer program, which is provided as a corresponding product stored on a suitable medium. The program consists of modules that are installed on one or more servers and modules that are installed on each client (which modules are also suitable to be put on the market as stand-alone products).

Alternatively, the program is pre-loaded onto each hard-disk, is sent to the computers via the Internet, is broadcast, or more generally is provided in any other form directly loadable into the working memories of the computers. However, the method according to the present invention leads itself to be carried out with an application having a different architecture or even with a hardware structure (for example, integrated in a chip of semiconductor material).

Naturally, in order to satisfy local and specific requirements, a person skilled in the art may apply to the solution described above many modifications and alterations all of which, however, are included within the scope of protection of the invention as defined by the following claims.

What is claimed is:

1. A method of managing a messaging service for use in a data processing system with distributed architecture including at least one server computer and a plurality of client computers, the service being provided by the at least one server computer for a plurality of users each one associated with a corresponding client computer, wherein the method includes the steps for each user of:
providing personal information of the user to the at least one server computer,
determining, under the control of the at least one server computer and for each other user, an affinity value indicating a level of affinity of the user with the other user according to a comparison between the personal information of the user and the personal information of the other user,
transmitting each affinity value from the at least one server computer to the client computer of the user, and
providing an indication of each affinity value to the user by means of the corresponding client computer.

2. The method according to claim 1, wherein the step of providing an indication of each affinity value to the user by means of the corresponding client computer includes:
displaying an identifier of each other user and a graphic representation of the corresponding affinity value on the client computer of the user.

3. The method according to claim 1, wherein the step of providing personal information of the user to the at least one server computer includes, under the control of the corresponding client computer:
enabling at least one among a plurality of predefined categories of personal information, and
setting a value for the enabled category.

4. The method according to claim 3, wherein the step of setting a value for the enabled category includes:
selecting one of a plurality of predefined values for the enabled category.

5. The method according to claim 3, wherein the step of determining, under the control of the at least one server computer and for each other user, an affinity value includes:
determining, for each category being enabled by both the user and the other user, a score according to a difference between the values being set for the category by the user and by the other user, and
calculating the affinity value according to the determined scores.

6. The method according to claim 1, wherein the step of providing personal information of the user to the at least one server computer includes, under the control of the corresponding client computer:
selecting a geographical position of the user.

7. The method according to claim 6, wherein the step of selecting a geographical position of the user includes:
selecting one of a plurality of predefined geographical localities.

8. The method according to claim 6, wherein the step of selecting a geographical position of the user includes:
displaying a graphic representation of a geographical map, and
selecting a point on the graphic representation of the geographical map.

9. The method according to claim 6, wherein the step of determining, under the control of the at least one server computer and for each other user, an affinity value includes:
determining a distance of the user from the other user according to a difference between the geographical position of the user and the geographical position of the other user, and
calculating the affinity value according to the distance.

10. The method according to claim 9, wherein the step of determining a distance of the user from the other user includes:
accessing a predefined data structure associating the corresponding geographical position with each geographical locality, and
obtaining the geographical position corresponding to the selected geographical locality from the data structure.

11. The method according to claim 1, further including the steps of:
updating the personal information of the user under the control of the client computer,
transmitting the updated personal information of the user to the at least one server computer,
determining a new affinity value for each other user according to a comparison between the updated personal information of the user and the personal information of the other user,
providing an indication of the corresponding new affinity value to each other user by means of the corresponding client computer, and
providing an indication of each new affinity value to the user by means of the corresponding client computer.

12. The method according to claim 11, wherein the step of determining the new affinity value is performed under the control of the at least one server computer, the method further including the steps of:
transmitting the corresponding new affinity value from the at least one server computer to the client computer of each other user, and
transmitting each new affinity value from the at least one server computer to the client computer of the user.

13. The method according to claim 1, wherein the messaging service is a real-time chat.

14. A computer program, directly loadable into a working memory of a data processing system with distributed architecture including at least one server computer and a plurality of client computers, for performing a method of managing a messaging service when the program is run on the system, the service being provided by the at least one server computer for a plurality of users each one associated with a corresponding client computer, wherein the method includes the steps for each user of:
providing personal information of the user to the at least one server computer,
determining, under the control of the at least one server computer and for each other user, an affinity value indicating a level of affinity of the user with the other user according to a comparison between the personal information of the user and the personal information of the other user,
transmitting each affinity value from the at least one server computer to the client computer of the user, and
providing an indication of each affinity value to the user by means of the corresponding client computer.

15. A program product comprising a computer readable medium storing a computer program, the program being directly loadable into a working memory of a data processing system with distributed architecture for performing a method of managing a messaging service when the program is run on the system, the service being provided by the at least one server computer for a plurality of users each one associated with a corresponding client computer, wherein the method includes the steps for each user of:
providing personal information of the user to the at least one server computer,
determining, under the control of the at least one server computer and for each other user, an affinity value indicating a level of affinity of the user with the other user according to a comparison between the personal information of the user and the personal information of the other user,
transmitting each affinity value from the at least one server computer to the client computer of the user, and
providing an indication of each affinity value to the user by means of the corresponding client computer.

16. In a data processing system with distributed architecture including at least one server computer and a plurality of client computers, a computer program directly loadable into a working memory of a server computer for performing a method of managing a messaging service when the program is run on the server computer, the service being provided by the at least one server computer for a plurality of users each one associated with a corresponding client computer, wherein the method includes the steps for each user of:
receiving personal information of the user,
determining, for each other user, an affinity value indicating a level of affinity of the user with the other user according to a comparison between the personal information of the user and the personal information of the other user, and
transmitting each affinity value to the client computer of the user to cause the client computer to provide an indication of each affinity value to the user.

17. In a data processing system with distributed architecture including at least one server computer and a plurality of client computers, a program product comprising a computer readable medium storing a computer program, the program being directly loadable into a working memory of a server computer for performing a method of managing a messaging service when the program is run on the server computer, the service being provided by the at least one server computer for a plurality of users each one associated with a corresponding client computer, wherein the method includes the steps for each user of:
receiving personal information of the user,
determining, for each other user, an affinity value indicating a level of affinity of the user with the other user according to a comparison between the personal information of the user and the personal information of the other user, and
transmitting each affinity value to the client computer of the user to cause the client computer to provide an indication of each affinity value to the user.

18. In a data processing system with distributed architecture including at least one server computer and a plurality of client computers, a computer program directly loadable into a working memory of a client computer for performing a method of managing a messaging service when the program is run on the client computer, the service being provided by the at least one server computer for a plurality of users each one associated with a corresponding client computer, wherein the method includes the steps of:
sending personal information of the user of the client computer to the at least one server computer to cause the at least one server computer to determine, for each other user, an affinity value indicating a level of affinity of the user with the other user according to a comparison between the personal information of the user and the personal information of the other user,
receiving each affinity value from the at least one server computer, and
providing an indication of each affinity value to the user.

19. In a data processing system with distributed architecture including at least one server computer and a plurality of client computers, a program product comprising a computer readable medium storing a computer program, the program being directly loadable into a working memory of a client computer for performing a method of managing a messaging service when the program is run on the client computer, the service being provided by the at least one server computer for a plurality of users each one associated with a corresponding client computer, wherein the method includes the steps of:
sending personal information of the user of the client computer to the at least one server computer to cause the at least one server computer to determine, for each other user, an affinity value indicating a level of affinity of the user with the other user according to a comparison between the personal information of the user and the personal information of the other user,
receiving each affinity value from the at least one server computer, and
providing an indication of each affinity value to the user.

20. A data processing system with distributed architecture for managing a messaging service including at least one server computer and a plurality of client computers, wherein the at least one server computer includes means for providing the messaging service for a plurality of users each one associated with a corresponding client computer, means for receiving personal information of each user, means for determining, for each other user, an affinity value indicating a level of affinity of the user with the other user according to a comparison between the personal information of the user and the personal information of the other user, and means for transmitting each affinity value to the client computer of the user, and wherein each client computer includes means for providing an indication of each affinity value to the user of the client computer.

21. In a data processing system with distributed architecture for managing a messaging service including at least one server computer and a plurality of client computers, a server computer including means for receiving personal information of each user, means for determining, for each other user, an affinity value indicating a level of affinity of the user with the other user according to a comparison between the personal information of the user and the personal information of the other user, and means for transmitting each affinity value to the client computer of the user to cause the client computer to provide an indication of each affinity value to the user.

22. In a data processing system with distributed architecture for managing a messaging service including at least one server computer and a plurality of client computers, the messaging service being provided by the at least one server computer for a plurality of users each one associated with a corresponding client computer, a client computer including means for sending personal information of the user of the client computer to the at least one server computer to cause the at least one server computer to determine, for each other user, an affinity value indicating a level of affinity of the user with the other user according to a comparison between the personal information of the user and the personal information of the other user, means for receiving each affinity value from the at least one server computer, and means for providing an indication of each affinity value to the user.
